(19) United States
(12) Patent Application Publication
(10) Pub. No.: US 2014/0362308 A1
(43) Pub. Date: Dec. 11, 2014

(54) SUBSTRATE STRUCTURE AND TOUCH PANEL INCLUDING THE SAME

(71) Applicants: Chien-Chung Chen, Taichung City (TW); Yi-Shu Chen, Taichung City (TW); Hen-Ta Kang, Taichung City (TW)

(72) Inventors: Chien-Chung Chen, Taichung City (TW); Yi-Shu Chen, Taichung City (TW); Hen-Ta Kang, Taichung City (TW)

(73) Assignee: WINTEK CORPORATION, Taichung City (TW)

(21) Appl. No.: 14/297,629

(22) Filed: Jun. 6, 2014

(30) Foreign Application Priority Data
Jun. 6, 2013 (TW) 102120123

(51) Int. Cl. G06F 3/0354

(52) U.S. Cl. CPC G06F 3/03547
USPC 349/12; 428/457; 428/408; 428/450; 428/76

(57) ABSTRACT

A substrate structure is provided. The substrate structure includes a substrate, a first decoration layer, and a light absorption layer. The first decoration layer is disposed on the substrate. The light absorption layer is disposed on the first decoration layer, and the first decoration layer is located between the substrate and the light absorption layer. The material of the light absorption layer includes a semiconductor metal alloy.

### CROSS-REFERENCE TO RELATED APPLICATION

This application claims the priority benefit of Taiwan application serial no. 102120123, filed on Jun. 6, 2013. The entirety of the above-mentioned patent application is hereby incorporated by reference herein and made a part of this specification.

### BACKGROUND OF THE INVENTION

1. Field of the Invention

The invention is related to a substrate structure and a touch panel including the same, and more particularly, to a substrate structure including a non-black decoration layer and a touch panel including the same.

2. Description of Related Art

In recent years, the touch panel has become widely used. To transmit the signal generated from the operation of the touch panel by the user, a wiring region having a plurality of transmission lines needs to be arranged in the periphery of the touch panel. In general, if the transmission lines in the wiring region are exposed to the outside, the overall appearance of the touch panel may be affected. As a result, a decoration layer is usually disposed on the transparent cover plate to shield where the transmission lines are.

In the current fabrication process, the decoration layer usually uses a black shading material, such as a black photoresist. However, to comply with fashion trends, non-black shading materials such as white photoresist and white ink have been actively developed to satisfy the user's needs for the appearance of the product. Using white ink as an example, dielectric particles with a high index of refraction such as titanium oxide (TiO₂) are usually added to the white ink, causing a high proportion of stray light and rendering white reflection. However, the inherent shading capability of such dielectric particles is inadequate, and therefore the shading of the white ink is insufficient to shield the transmission lines. In general, to achieve an effective shading effect, the number of stacks of the current white decoration layer is increased or the thickness of the white ink thereof is significantly increased. As a result, the difference in thickness between the white decoration layer and the cover plate may cause disconnection issues in the subsequent fabrication of the transmission lines.

### SUMMARY OF THE INVENTION

The invention provides a substrate structure. The substrate structure provides good visual effects through the disposition of a light absorption layer on a decoration layer.

The invention further provides a touch panel. The touch panel provides good visual effects and improves production yield through the disposition of a light absorption layer on a decoration layer.

The invention provides a substrate structure. The substrate structure includes a substrate, a first decoration layer, and a light absorption layer. The first decoration layer is disposed on the substrate. The light absorption layer is disposed on the first decoration layer, and the first decoration layer is located between the substrate and the light absorption layer. The material of the light absorption layer includes a semiconductor metal alloy.

The invention further provides a touch panel. The touch panel includes a substrate, a first decoration layer, a light absorption layer, and a plurality of sensing electrodes. The substrate has an operating region and a peripheral region surrounding the operating region. The first decoration region is disposed on the substrate and located in the peripheral region. The light absorption layer is disposed on the first decoration layer, and the first decoration layer is located between the substrate and the light absorption layer. The light absorption layer includes a semiconductor metal alloy. The sensing electrodes are disposed on the substrate and located in the operating region.

Based on the above, the substrate structures and the touch panels provided by the embodiments of the invention can further improve shading effects through the disposition of the light absorption layer on the decoration layer, thereby providing good visual effects and improving the production yield of the touch panel.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a substrate structure of the first embodiment of the invention.

FIG. 2 is a simulation diagram of transmittance against wavelength of the light absorption layer 104, wherein the content of silicon and the content of aluminum of the light absorption layer 104 are both 50 wt % and the thickness of the light absorption layer 104 is 100 nm.

FIG. 3 is a simulation diagram of transmittance against wavelength of the light absorption layer 104, wherein the content of silicon and the content of aluminum of the light absorption layer 104 are both 50 wt % and the thickness of the light absorption layer 104 is 200 nm.

FIG. 4 is a simulation diagram of transmittance against wavelength of the light absorption layer 104, wherein the content of silicon of the light absorption layer 104 is 70 wt %, the content of aluminum of the light absorption layer 104 is 30 wt %, and the thickness of the light absorption layer 104 is 100 nm.

FIG. 5 is a simulation diagram of transmittance against wavelength of the light absorption layer 104, wherein the content of silicon of the light absorption layer 104 is 70 wt %, the content of aluminum of the light absorption layer 104 is 30 wt %, and the thickness of the light absorption layer 104 is 200 nm.

FIG. 6 is a schematic cross-sectional view of a substrate structure of the second embodiment of the invention.

FIG. 7 is a schematic cross-sectional view of a substrate structure of the third embodiment of the invention.

FIG. 8 is a schematic cross-sectional view of a substrate structure of the fourth embodiment of the invention.

FIG. 9 is a schematic cross-sectional view of a substrate structure of the fifth embodiment of the invention.

FIG. 10 is a schematic cross-sectional view of a substrate structure of the sixth embodiment of the invention.

FIG. 11 is a schematic cross-sectional view of a substrate structure of the seventh embodiment of the invention.

FIG. 12 is a schematic top view of a touch panel of the eighth embodiment of the invention.

FIG. 13 is a schematic cross-sectional view of the touch panel of FIG. 12 along line I-I′.

FIG. 14A is a schematic cross-sectional view of a structural design of the touch panel of FIG. 12 along line II-II′.

FIG. 14B is a schematic cross-sectional view of a structural design of the touch panel of FIG. 12 along line III-III′.

FIG. 14C is a schematic cross-sectional view of another structural design of the touch panel of FIG. 12 along line II-II′.

FIG. 14D is a schematic cross-sectional view of another structural design of the touch panel of FIG. 12 along line III-III′.

FIG. 15 is a partial schematic cross-sectional view of a touch panel of the ninth embodiment of the invention.

FIG. 16 is a schematic top view of a touch panel of the tenth embodiment of the invention.

FIG. 17 is a schematic cross-sectional view of the touch panel of FIG. 16 along line IV-IV′.

FIG. 18 is a schematic top view of a touch panel of the eleventh embodiment of the invention.

FIG. 19 is a schematic cross-sectional view of the touch panel of FIG. 18 along line V-V′.

### DESCRIPTION OF THE EMBODIMENTS

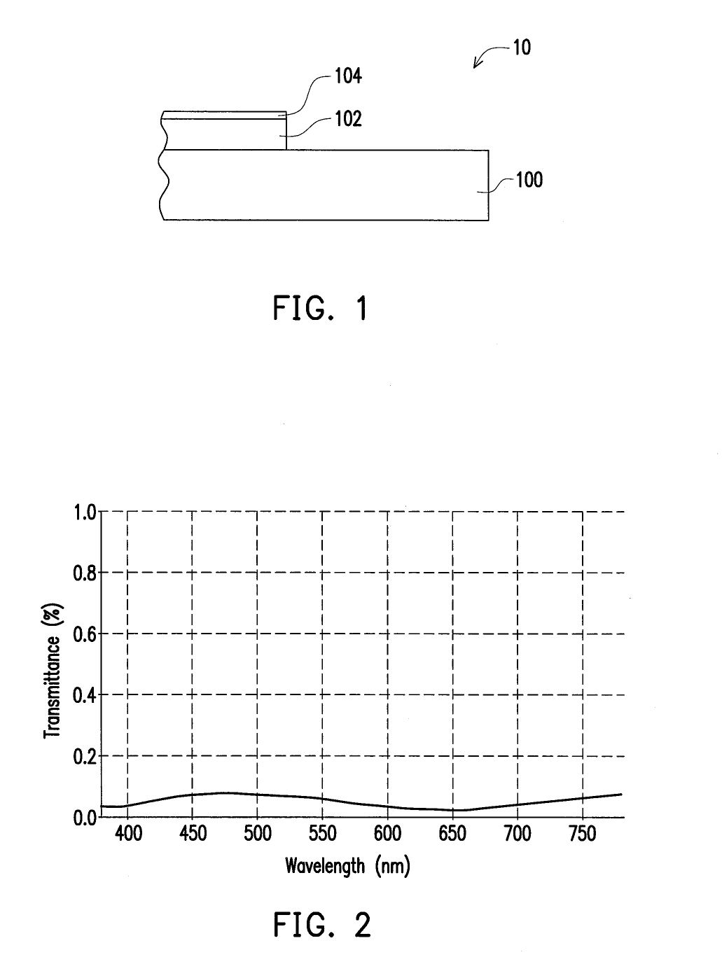

FIG. 1 is a schematic cross-sectional view of a substrate structure of the first embodiment of the invention.

Referring to FIG. 1, a substrate structure 10 includes a substrate 100, a decoration layer 102, and a light absorption layer 104.

The substrate 100 can be a glass substrate or a plastic substrate. However, the invention is not limited thereto.

The decoration layer 102 is disposed on the substrate 100 to provide the user with the desired visual effects. For instance, the decoration layer 102 can be a specific decorative pattern. The material of the decoration layer 102 is, for instance, ink, photoresist, resin, or a combination thereof. In an embodiment, the decoration layer 102 is, for instance, white ink. In another embodiment, the decoration layer 102 is, for instance, a non-black decoration layer, and more particularly, a white decoration layer. Of course, the decoration layer 102 can also be a colored decoration layer of a color other than white. Specifically, when the decoration layer 102 is a non-black ink, the decoration layer 102 can be used to provide white or colored patterned decorative patterns such as labels, patterns, and letters for products.

The method of forming the decoration layer 102 is, for instance, a screen printing process or a lithography process. In the present embodiment, the decoration layer 102 is a single-layer structure. However, the invention is not limited thereto. In other embodiments, the decoration layer 102 can also be a multilayer structure according to actual design requirements. The description of the decoration layer 102 as a multilayer structure is explained in detail in the following.

The light absorption layer 104 is disposed on the decoration layer 102 and the decoration layer 102 is located between the substrate 100 and the light absorption layer 104. The material of the light absorption layer 104 includes a semiconductor metal alloy. In the semiconductor metal alloy, the content of a metal material is 5 wt % to 50 wt %. The semiconductor material of the semiconductor metal alloy is, for instance, silicon (Si), germanium (Ge), tin (Sn), indium (In), or an alloy thereof and the metal material is, for instance, aluminum (Al), silver (Ag), copper (Cu), chromium (Cr), platinum (Pt), or an alloy thereof. In the present embodiment, the semiconductor material of the semiconductor metal alloy is silicon and the metal material is aluminum. That is, the semiconductor metal alloy is a silicon aluminum (SiAl) alloy.

The method of forming the light absorption layer 104 includes, for instance, physical vapor deposition (PVD) or chemical vapor deposition (CVD), wherein physical vapor deposition includes sputtering or evaporation. Specifically, during physical vapor deposition, a binary target materials or an alloy target material can be used to form the light absorption layer 104. For instance, when the material of the light absorption layer 104 is a SiAl alloy, both Si and Al targets can be used to perform sputtering or evaporation on the light absorption layer 104. Alternately, a SiAl alloy target can be used to perform sputtering or evaporation on the light absorption layer 104.

Moreover, since the light absorption layer 104 is formed by a semiconductor metal alloy, the light absorption layer 104 can have light absorption properties through the metal material in the semiconductor metal alloy. In general, the light absorption properties are related to the thickness of the film. That is, the light absorption properties improve with increasing thickness of the light absorption layer 104. In an embodiment, the thickness of the light absorption layer 140 is, for instance, 20 nm to 500 nm. Moreover, through the semiconductor material in the semiconductor metal alloy, the light absorption layer 104 can have insulating properties and properties that decrease the high reflectance of the metal material. In other words, the light absorption layer 104 does not have the general high reflectance properties of a metal material.

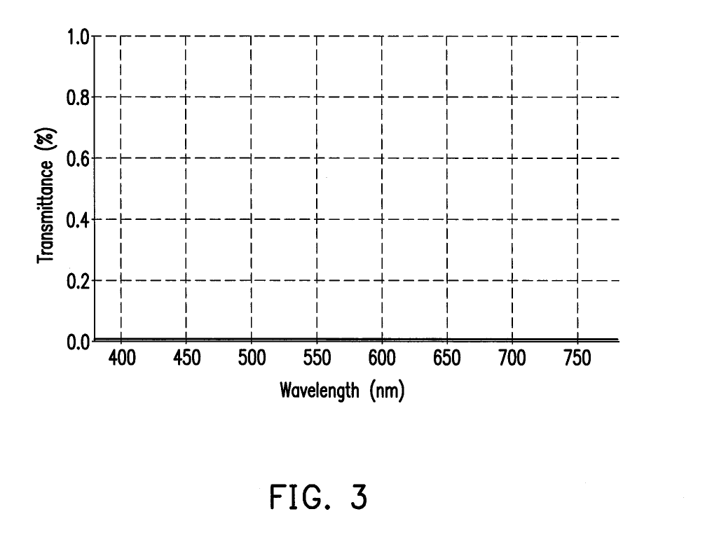

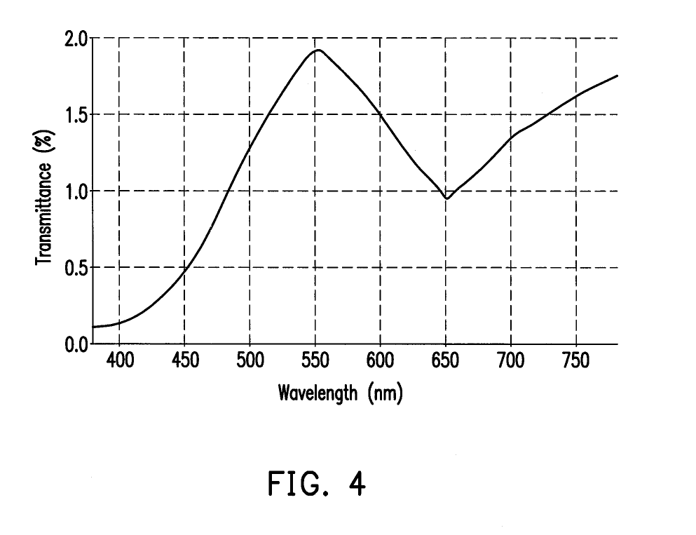

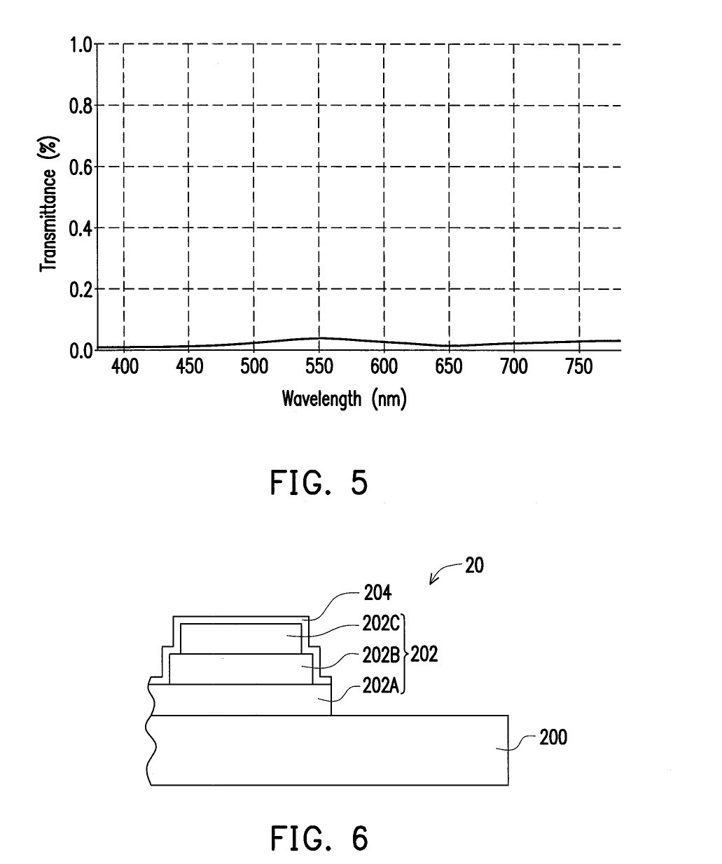

Specifically, FIG. 2 is a simulation diagram of transmittance against wavelength of the light absorption layer 104, wherein the light absorption layer 104 is a silicon aluminum alloy, the content of silicon and the content of aluminum are both 50 wt %, and the thickness of the light absorption layer 104 is 100 nm. FIG. 3 is a simulation diagram of transmittance against wavelength of the light absorption layer 104, wherein the light absorption layer 104 is a silicon aluminum alloy, the content of silicon and the content of aluminum are both 50 wt %, and the thickness of the light absorption layer 104 is 200 nm. FIG. 4 is a simulation diagram of transmittance against wavelength of the light absorption layer 104, wherein the light absorption layer 104 is a silicon aluminum alloy, the content of silicon is 70 wt %, the content of aluminum is 30 wt %, and the thickness of the light absorption layer 104 is 100 nm. FIG. 5 is a simulation diagram of transmittance against wavelength of the light absorption layer 104, wherein the light absorption layer 104 is a silicon aluminum alloy, the content of silicon is 70 wt %, the content of aluminum is 30 wt %, and the thickness of the light absorption layer 104 is 200 nm.

It is known from FIG. 2 and FIG. 3 that, in the range of the visible wavelength, the transmittance of each of the light absorption layers 104 of the invention is less than 0.2%. In other words, the light absorption layer 104 has good light absorption properties, and the transmittance improves with increasing thickness of the light absorption layer 104. It is known from FIG. 2 and FIG. 4 that, the content of aluminum in the light absorption layer 104 is reduced, and therefore the transmittance of the light absorption layer 104 is increased. However, in the range of the visible wavelength, the transmittance of each of the light absorption layers 104 of the invention with reduced content of aluminum is less than 2%, similarly indicating that the light absorption layer 104 has good light absorption properties. Moreover, it is known from FIG. 4 and FIG. 5 that, the transmittance of the light absorption layer 104 is also improved with increasing thickness of the light absorption layer 104. Based on the above, it is known that the light absorption layer 104 of the invention can have good shading effects when the thickness thereof is nanoscale.

In general, the material selected for the decoration layer 102 of the present embodiment is a non-black material. The shading effects of such material may not be the same as those of a black material, causing interference to the decoration layer 102 from background light. As a result, desired visual effects such as high color saturation or a completely shielded background may not be achieved. However, as described above, as long as the thickness of the light absorption layer 104 is nanoscale, the light absorption effect will be good. Therefore, through the disposition of the light absorption layer 104, the light absorption layer 104 can compensate the inadequate shading effects of the decoration layer 102, thereby rendering the substrate structure 10 of the invention excellent visual effects, such as the pattern formed by the decoration layer 102 having the desired color saturation.

Moreover, in general, when the decoration layer 102 is a single layer of white ink with a thickness of between about 5 μm and 8 μm, the shading effects are not great. Therefore, under such circumstances, the thickness is usually increased, or a dark shading layer is disposed in the rear so as to improve the shading effects of the decoration layer 102. In this way, in the present embodiment, the thickness of the decoration layer 102 can be reduced by disposing the light absorption layer 104 on the decoration layer 102 to achieve the same shading effect, and thereby reducing the overall thickness of the substrate structure 10 to satisfy the demand for a thin substrate structure. Moreover, the light absorption layer 104 disposed on the decoration layer 102 can provide the same function as a dark shading layer, and therefore can also prevent color distortion of the decoration layer caused by the color of the dark shading layer (such as a black photoresist) from permeating to the white ink at the front.

FIG. 6 is a schematic cross-sectional view of a substrate structure of the second embodiment of the invention. Referring to FIG. 6, a substrate structure 20 includes a substrate 200, a decoration layer 202, and a light absorption layer 204. The substrate 200 can be the same as the corresponding substrate in the first embodiment and is not repeated herein.

In comparison to the design of the first embodiment, the decoration layer 102 thereof is a single-layer structure while the decoration layer 202 of the present embodiment is a multilayer structure. Similarly to the decoration layer 102, the material of the decoration layer 202 is, for instance, ink, photoresist, resin, or a combination thereof. Moreover, the decoration layer 202 can provide the user with the desired visual effects. For instance, the decoration layer 202 can be a specific decorative pattern. In an embodiment, the decoration layer 202 is, for instance, white ink.

Moreover, in the present embodiment, the decoration layer 202 sequentially includes, from the substrate 200, a first decoration layer 202A, a second decoration layer 202B, and a third decoration layer 202C. Moreover, the first decoration layer 202A, the second decoration layer 202B, and the third decoration layer 202C are arranged in a descending order of, according to widths thereof, the first decoration layer 202A, the second decoration layer 202B, and the third decoration layer 202C. In other words, at least two layers of structures of the multilayer structure of the decoration layer 202 can have different sizes. However, the invention is not limited to the decoration layer 202 illustrated in FIG. 6. In general, the shading effects of the decoration layer 202 improve as the number of layers of the decoration layer 202 increases. Therefore, the number of layers of the decoration layer 202 and the size of each layer are not limited, provided such parameters satisfy the desired visual design.

The light absorption layer 204 can be the same as the corresponding light absorption layer in the first embodiment and is not repeated herein. Moreover, in the present embodiment, the light absorption layer 204 illustrated in FIG. 6 is formed according to the profile of the decoration layer 202. However, the invention is not limited thereto. Provided the light absorption layer 204 is disposed on the decoration layer 202, the shading effects of the decoration layer 202 can be compensated. For instance, the light absorption layer 204 can be only disposed on the third decoration layer 202C, only disposed between the first and second decoration layers 202A and 202B, or only disposed between the second and third decoration layers 202B and 202C. In this way, in the second embodiment, the substrate structure 20 can similarly render better visual effects by disposing the light absorption layer 204 on the decoration layer 202 and reduce the thickness needed for the decoration layer 202, thereby reducing the overall thickness of the substrate structure 20 to satisfy the demand for a thin substrate structure.

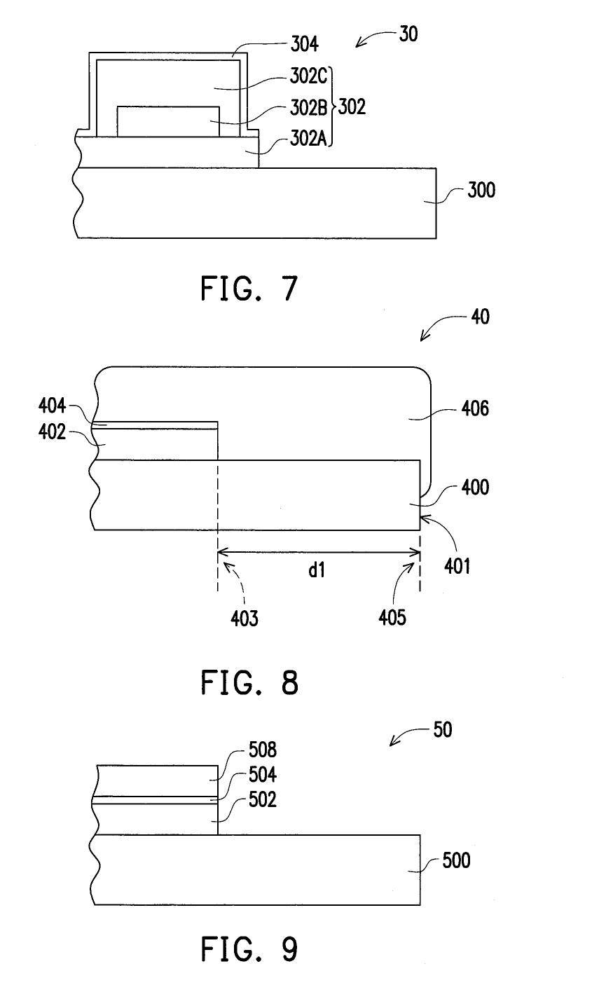

FIG. 7 is a schematic cross-sectional view of a substrate structure of the third embodiment of the invention. Referring to FIG. 7, a substrate structure 30 includes a substrate 300, a decoration layer 302, and a light absorption layer 304. The substrate 300 can be the same as the corresponding substrate in the first embodiment and is not repeated herein.

In comparison to the design of the first embodiment, the decoration layer 102 thereof is a single-layer structure while the decoration layer 302 of the present embodiment is a multilayer structure. Similarly to the decoration layer 102, the material of the decoration layer 302 is, for instance, ink, photoresist, resin, or a combination thereof. Moreover, the decoration layer 302 can provide the user with the desired visual effects. For instance, the decoration layer 302 can be a specific decorative pattern. In an embodiment, the decoration layer 302 is, for instance, white ink.

Moreover, in the present embodiment, the decoration layer 302 sequentially includes, from the substrate 300, a first decoration layer 302A, a second decoration layer 302B, and a third decoration layer 302C. Moreover, both the first decoration layer 302A and the third decoration layer 302C cover the second decoration layer 302B. In other words, the first decoration layer 302A, the second decoration layer 302B, and the third decoration layer 302C are arranged in a descending order of, according to widths thereof, the first decoration layer 302A, the third decoration layer 302C, and the second decoration layer 302B. Similarly to the description of the decoration layer 202, at least two layers of structures of the multilayer structure of the decoration layer 302 can have different sizes, and the invention is not limited to the decoration layer 302 illustrated in FIG. 7. Moreover, in other embodiments, the first decoration layer 302A and the third decoration layer 302 can have the same widths, and by extension the same areas.

The light absorption layer 304 can be the same as the corresponding light absorption layer in the first embodiment and is not repeated herein. In this way, in the third embodiment, the substrate structure 30 can similarly render better visual effects by disposing the light absorption layer 304 on the decoration layer 302 and reduce the thickness needed for the decoration layer 302, thereby reducing the overall thickness of the substrate structure 30. Moreover, the light absorption layer 304 can also be only disposed on the third decoration layer 302C, only disposed between the first and second decoration layers 302A and 302B, or only disposed between the second and third decoration layers 302B and 302C.

FIG. 8 is a schematic cross-sectional view of a substrate structure of the fourth embodiment of the invention. Referring to FIG. 8, a substrate structure 40 includes a substrate 400, a decoration layer 402, a light absorption layer 404, and a shielding layer 406. The substrate 400, the decoration layer 402, and the light absorption layer 404 can be the same as the equivalents thereof in the first embodiment and are not repeated herein.

In the fourth embodiment, when an outer edge 403 of the decoration layer 402 and a border 405 of the substrate 400 are separated by a distance d1, the substrate structure 40 can optionally include a shielding layer 406.

The material of the shielding layer 406 is, for instance, ink, photoresist, resin, diamond-like carbon, or any shading material. The shielding layer 406 is at least located between the outer edge 403 of the decoration layer 402 and the border 405 of the substrate 400, and extends to cover at least a portion of a side surface 401 of the substrate 400, even further covering the upper surface of the light absorption layer 404. In FIG. 8, the shielding layer 406 is illustrated to cover the entire light absorption layer 404 and the decoration layer 402 and extend to at least a portion of the side surface 401 of the substrate 400. However, the invention is not limited thereto, as long as the shielding layer 406 is formed between the outer edge 403 of the decoration layer 402 and the border 405 of the substrate 400 and on at least a portion of the side surface 401 of the substrate 400. In other words, the shielding layer 406 needs to cover the substrate 400 between the outer edge 403 of the decoration layer 402 and the border 405 of the substrate 400. Of course, this is only an implementation provided to achieve the design of fabricating the decorative pattern in the periphery of the substrate 400. When the decorative pattern is fabricated in the center of the substrate and does not need to be completely extended to the border 405 of the substrate 400, the shielding layer 406 can be optionally omitted.

Moreover, in the fourth embodiment, by disposing the light absorption layer 404 on the decoration layer 402, the substrate structure 40 can similarly render better visual effects and reduce the thickness needed for the decoration layer 402, thereby reducing the overall thickness of the substrate structure 40.

FIG. 9 is a schematic cross-sectional view of a substrate structure of the fifth embodiment of the invention. Referring to FIG. 9, a substrate structure 50 includes a substrate 500, a decoration layer 502, a light absorption layer 504, and another decoration layer 508. The substrate 500, the decoration layer 502, and the light absorption layer 504 can be the same as the equivalents thereof in the first embodiment and are not repeated herein.

The decoration layer 508 is disposed on the light absorption layer 504. That is, the light absorption layer 504 is located between the decoration layer 502 and the decoration layer 508. In this way, through the disposition of the decoration layer 502 and the decoration layer 508, both the front and the back of the substrate structure 50 can render the desired visual effects of the user. Here, the “front of the substrate structure 50” refers to the surface of the substrate 500 on which the decoration layer 502 is not disposed and the “back of the substrate structure 50” refers to the surface of the substrate 500 on which the decoration layer 502 is disposed.

Moreover, the material of the decoration layer 508 is, for instance, ink, photoresist, resin, diamond-like carbon, or any shading material. In other words, the decoration layer 508 of the present embodiment can be a black decoration layer or a non-black decoration layer. The method of forming the decoration layer 508 is, for instance, a screen printing process or a lithography process.

It should be mentioned that, the substrate structure of the invention is not limited to the substrate structure 50 illustrated in FIG. 9. In other words, based on the contents disclosed by the second embodiment and the third embodiment, those skilled in the art can deduce the structure of the substrate structure obtained when the decoration layer 502 is a multilayer. Moreover, those skilled in the art can similarly deduce the structure when the substrate structure 50 further includes a shielding layer based on the contents disclosed by the fourth embodiment.

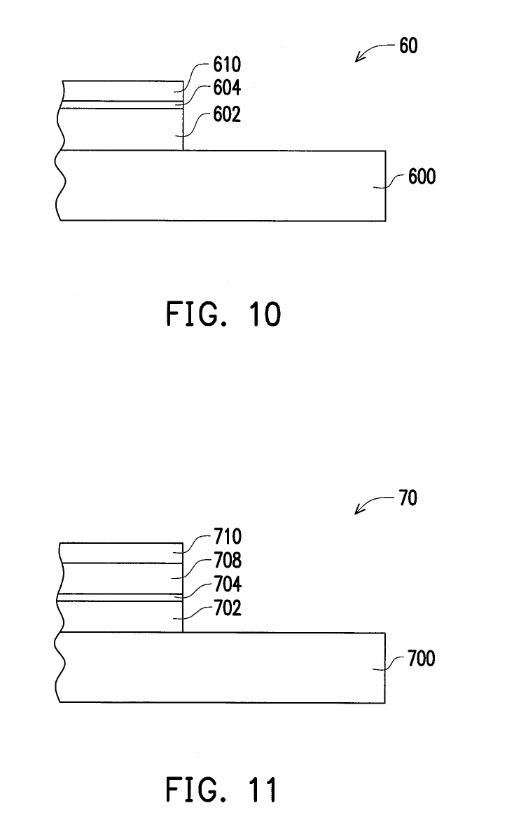

FIG. 10 is a schematic cross-sectional view of a substrate structure of the sixth embodiment of the invention. Referring to FIG. 10, a substrate structure 60 includes a substrate 600, a decoration layer 602, a light absorption layer 604, and an insulating layer 610. The substrate 600, the decoration layer 602, and the light absorption layer 604 can be the same as the equivalents thereof in the first embodiment and are not repeated herein.

The insulating layer 610 is disposed on the light absorption layer 604. That is, the light absorption layer 604 is located between the decoration layer 60 and the insulating layer 610. In this way, through the disposition of the insulating layer 610, the insulation property of the light absorption layer 604 can be further improved such that the substrate structure of the present embodiment can be more widely applied.

Moreover, the material of the insulating layer 610 is, for instance, silicon oxide, titanium oxide, aluminum oxide, or other suitable oxide dielectric materials. The method of forming the insulating layer 610 is, for instance, PVD, CVD, or a coating method, wherein PVD includes sputtering or evaporation and the coating method includes the use of a sol-gel coating.

It should be mentioned that, the substrate structure of the invention is not limited to the substrate structure 60 illustrated in FIG. 10. In other words, based on the contents disclosed by the second embodiment and the third embodiment, those skilled in the art can deduce the structure of the substrate structure obtained when the decoration layer 602 is a multilayer. Moreover, based on the contents disclosed by the fourth embodiment, those skilled in the art can similarly deduce the structure when the substrate structure 60 further includes a shielding layer.

FIG. 11 is a schematic cross-sectional view of a substrate structure of the seventh embodiment of the invention. Referring to FIG. 11, a substrate structure 70 includes a substrate 700, a decoration layer 702, a light absorption layer 704, a decoration layer 708, and an insulating layer 710. The substrate 700, the decoration layer 702, the light absorption layer 704, and the decoration layer 708 can be the same as the equivalents thereof in the fifth embodiment and are not repeated herein.

In the present embodiment, the insulating layer 710 is disposed on the decoration layer 708 and the decoration layer 708 is located between the light absorption layer 704 and the insulating layer 710. The material of the insulating layer 710 is, for instance, silicon oxide, titanium oxide, aluminum oxide, or other suitable oxide dielectric materials. The method of forming the insulating layer 710 is, for instance, PVD, CVD, or a coating method, wherein PVD includes sputtering or evaporation and the coating method includes the use of a sol-gel coating.

Moreover, although the decoration layer 708 in FIG. 11 is illustrated as disposed on the light absorption layer 704 and located between the light absorption layer 704 and the insulating layer 710, the invention is not limited thereto. In other embodiments, based on actual design requirements, the insulating layer 710 can also be disposed on the light absorption layer 704 and located between the light absorption layer 704 and the decoration layer 708. In other words, at this point, the insulating layer 710 is the same as the insulating layer 610 in the sixth embodiment.

It should be mentioned that, the substrate structure of the invention is not limited to the substrate structure 70 illustrated in FIG. 11. In other words, based on the contents disclosed by the second embodiment and the third embodiment, those skilled in the art can deduce the structure of the substrate structure obtained when the decoration layer 702 is a multilayer. Moreover, based on the contents disclosed by the fourth embodiment, those skilled in the art can similarly deduce the structure when the substrate structure 70 further includes a shielding layer.

The substrate structure of the invention is explained above through various embodiments based on the concepts of the invention. However, the substrate structures 10, 20, 30, 40, 50, 60, and 70 proposed in each embodiment above are only used as examples and are not used to limit the invention.

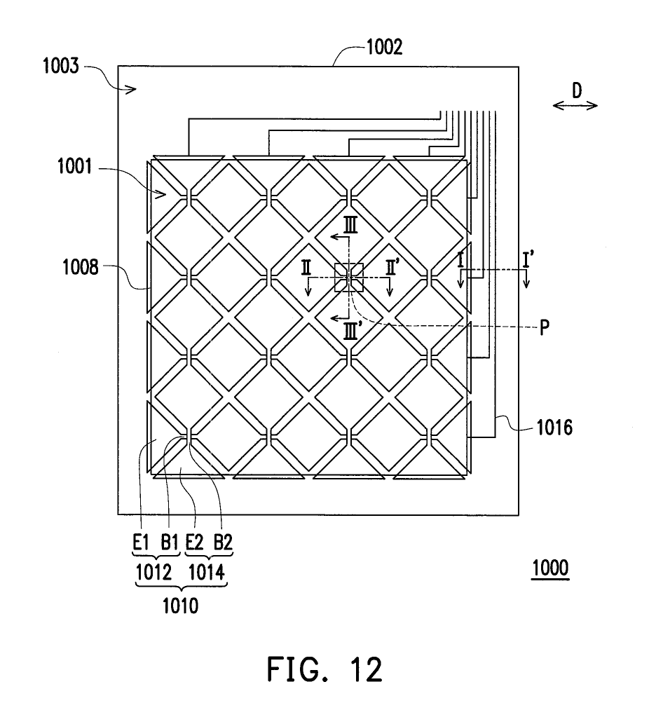

Moreover, through the disposition of the decoration layer and the light absorption layer, each substrate structure of the invention can render the desired visual effects of the user and have good shading effects at the same time. Therefore, each substrate structure of the invention can be applied in devices such as a touch panel or a liquid crystal display to shield components such as an electrical lead in the device not to be seen by the user, thereby rendering the device with good appearance. In the following, the touch panel of the invention is explained with FIG. 12 to FIG. 19.

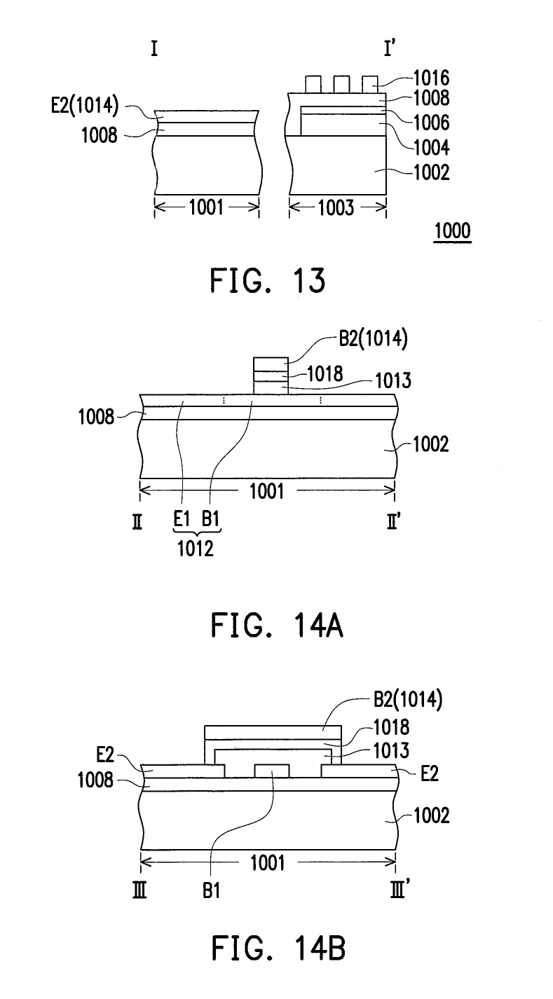

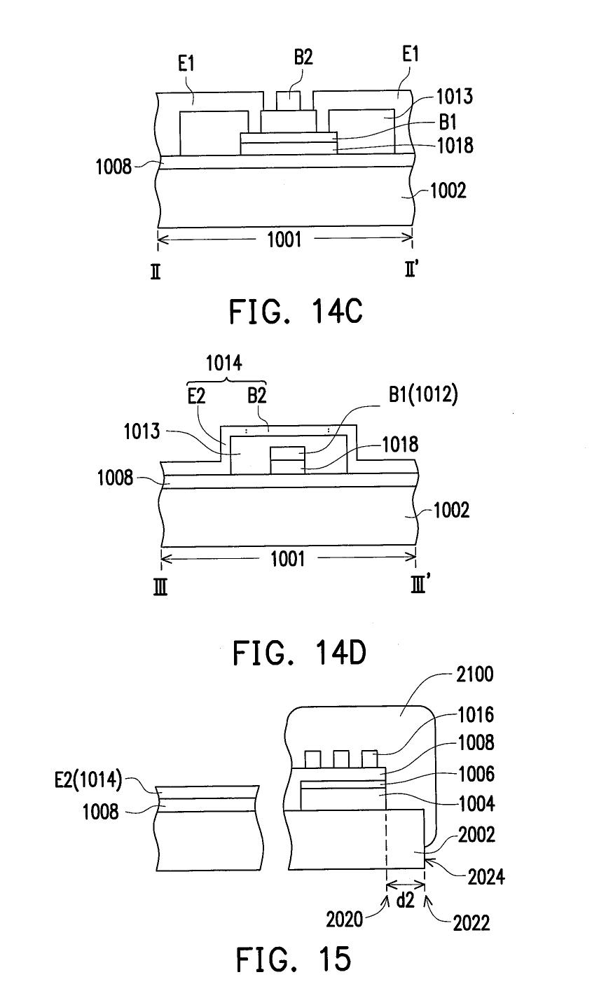

FIG. 12 is a schematic top view of a touch panel of the eighth embodiment of the invention. FIG. 13 is a schematic cross-sectional view of the touch panel of FIG. 12 along line I-I′. FIG. 14A is a schematic cross-sectional view of a structural design of the touch panel of FIG. 12 along line II-II′. FIG. 14B is a schematic cross-sectional view of a structural design of the touch panel of FIG. 12 along line III-III′. FIG. 14C is a schematic cross-sectional view of another structural design of the touch panel of FIG. 12 along line II-II′. FIG. 14D is a schematic cross-sectional view of another structural design of the touch panel of FIG. 12 along line III-III′.

Referring to FIG. 12, FIG. 13 and FIG. 14A to FIG. 14D, the touch panel 1000 includes a substrate 1002, a decoration layer 1004, a light absorption layer 1006, an insulating layer 1008, a plurality of sensing electrodes 1010, and a plurality of transmission lines 1016.

The substrate 1002 has an operating region 1001 and a peripheral region 1003 surrounding the operating region 1001. The substrate 1002 can be a glass substrate or a plastic substrate. However, the invention is not limited thereto. Moreover, in the present embodiment, the substrate 1002 can also be used as a cover plate for an electronic device and be the outermost structure of the electronic device.

The sensing electrodes 1010 are disposed on the substrate 1002 and located in the operating region 1001. The sensing electrodes 1010 include a plurality of first electrodes 1012 and a plurality of second electrodes 1014. The first electrodes 1012 are electrodes respectively extending along a direction D and the second electrodes 1014 are electrodes respectively having a direction of extension intersecting with the direction D. Here, each first electrode 1012 can include a plurality of first sensing pads E1 and a plurality of bridge connections B1, wherein each bridge connection B1 is connected between two first sensing pads E1. Similarly, each second electrode 1014 can include a plurality of second sensing pads E2 and a plurality of bridge connections B2, wherein each bridge connection B2 is connected between two second sensing pads E2.

The material of each of the first sensing pads E1 and the bridge connections B1 of the first electrodes 1012 and the second sensing pads E2 and the bridge connections B2 of the second electrodes 1012 can be the same or different, and is selected from metal, a transparent conductive material, or a combination of the materials, wherein a transparent conductive material is preferred. The transparent conductive material is, for instance, indium tin oxide, indium zinc oxide, aluminum zinc oxide, nano-silver yarns, graphene, or a mixture or layers thereof. However, the invention is not limited thereto. In other embodiments, the first electrodes 1012 and the second electrodes 1014 can also use a mesh pattern to form the desired electrode pattern. Moreover, at this point, the material of each of the first electrodes 1012 and the second electrodes 1014 is metal, wherein the metal is, for instance, Mo/Al/Mo. Moreover, in FIG. 12, although the pattern of each of the first sensing pads E1 and the second sensing pads E2 is rhombic, the invention is not limited thereto. In other embodiments, the pattern of each of the first sensing pads E1 and the second sensing pads E2 can also be defined according to product requirements.

In the present embodiment, the first electrodes 1012 and the second electrodes 1014 are electrically independent from each other and the first electrodes 1012 are interlaced with the second electrodes 1014 to form a plurality of junctions P. In other words, the bridge connections B1 are interlaced with the bridge connections B2 to form the junctions P. Therefore, in the present embodiment, to prevent electrical contact between the first electrodes 1012 and the second electrodes 1014, an insulating pattern 1013 shown in FIG. 14A-14D is formed at the junctions P to separate the two. More specifically, the bridge connections B1 used to connect the first sensing pads E1 are essentially in a different conductive layer in the touch panel 1000 than the bridge connections B2 used to connect the second sensing pads E2.

The transmission lines 1016 are disposed on the substrate 1002 and extend into the peripheral region 1003 from the operating region 1001. The transmission lines 1016 electrically connect the sensing electrodes 1010 and are used to transmit the sensing or driving signals of the sensing electrodes 1010. Therefore, the transmission lines 1016 are respectively connected to the corresponding sensing electrodes 1010. Moreover, the sensing electrodes 1010 and the transmission lines 1016 can be formed by the same or different materials, wherein the materials can be selected from the ones listed in the description of the sensing electrodes 1010 and are therefore not repeated herein.

The decoration layer 1004 is disposed on the substrate 1002 and located in the peripheral region 1003. The light absorption layer 1006 is disposed on the decoration layer 1004 and the decoration layer 1004 is located between the substrate 1002 and the light absorption layer 1006, wherein the light absorption layer 1006 includes a semiconductor metal alloy. In the semiconductor metal alloy, the content of the metal material is 5 wt % to 50 wt %. The insulating layer 1008 is disposed on the light absorption layer 1006. Here, the structure of the present embodiment formed by the substrate 1002, the decoration layer 1004, the light absorption layer 1006, and the insulating layer 1008 is similar to the substrate structure 60 in the sixth embodiment. That is, except for the insulating layer 1008 extending to cover the side surface of the decoration layer 1004 and the light absorption layer 1006 adjacent to the operating region 1001 and the substrate 1002, the material, the properties, and the formation method . . . etc. of each of the decoration layer 1004, the light absorption layer 1006, and the insulating layer 1008 of the present embodiment can be the same as the equivalent decoration layer 602, light absorption layer 604, and insulating layer 610 in the sixth embodiment. Therefore, the same particulars are not repeated herein.

More specifically, in the present embodiment, through the disposition of the insulating layer 1008, the insulation of the light absorption layer 1006 can be further improved, thereby reducing electrical interference from the light absorption layer 1006 to the touch panel 1000. For instance, through the disposition of the insulating layer 1008, the possibility of electrical contact between the light absorption layer 1006 and the transmission lines 1016 can be avoided, thereby preventing the occurrence of a short-circuit. Moreover, the insulating layer 1008 in the operating region 1001 can be used as a buffer layer to prevent the issues of lattice dislocation and defect generated furing forming the second sensing pads E2 of the second electrodes 1014 and the first electrodes 1012 on the substrate 1002. In other words, the insulating layer 1008 used as a buffer layer can improve the adhesion of the second sensing pads E2 of the second electrodes 1014 and the first electrodes 1012 fabricated on the substrate 1002.

Moreover, the decoration layer 1004 and the light absorption layer 1006 are located between the transmission lines 1016 in the peripheral region 1003 and the substrate 1002. It is known from the disclosed contents of the previous descriptions relating to the substrate structure that the material of the decoration layer 1004 is a light-resisting material, and therefore the decoration layer 1004 can not only be used to provide the desired visual effects to the user, but can also have shielding functions at the same time. Moreover, the light absorption layer 1006 has good light absorption effects. Here, the light-resisting material is defined as a material to which loss of light occurs when light passes through the interface of the material. Therefore, in the present embodiment, through the disposition of the decoration layer 1004 and the light absorption layer 1006, not only can the desired visual effects such as a white or a non-black frame be provided to the touch panel 1000, the transmission lines 1016 in the touch panel 1000 can also be effectively shielded from the user's view to enhance the appearance of the touch panel 1000.

Moreover, in the present embodiment, the decoration layer 1004, the light absorption layer 1006, and the insulating layer 1008 are used as the frame of the touch panel 1000 and are disposed in the peripheral region 1003. However, the invention is not limited thereto. In other embodiments, the decoration layer 1004, the light absorption layer 1006, and the insulating layer 1008 can be disposed only in correspondence to the location of the transmission lines 1016. Alternately, the decoration layer 1004, the light absorption layer 1006, and the insulating layer 1008 can be disposed only for decorative purposes.

Moreover, as described above, the decoration layer 1004 may not, in general, have good shading effects. For instance, when the decoration region 1004 is white ink, the thickness of the decoration region 1004 needs to be greater than about 20 μm to achieve the desired shielding effects. However, in the present embodiment, through the disposition of the light absorption layer 1006 having nanoscale thickness and good shading effects, the inadequacy of the shading effects of the decoration layer 1004 can be compensated. In other words, to achieve the same shading effects, the overall thickness of the decoration layer 1004 and the light absorption layer 1006 is reduced compared to the thickness of the shielding component on which the light absorption layer 1006 is not disposed. Therefore, in the present embodiment, when the decoration layer 1004 achieves the visual effects to be rendered by the touch panel 1000, the need to shield the transmission lines 1016 can also be achieved through the disposition of the light absorption layer 1006. Therefore, in addition to enhancing the appearance of the touch panel 1000, the overall thickness of the decoration layer 1004 and the light absorption layer 1006 can also be reduced. As a result, the issue of disconnection of the transmission lines 1016 near the peripheral region 1003 can be avoided, thereby increasing the production yield of the touch panel 1000.

It should be mentioned that, under a different structural design, the material of any one of the bridge connections B2 of the second electrodes 1014 and the bridge connections B1 of the first electrodes 1012 can be metal, wherein the high reflectance properties of the metal readily cause the incident light to be reflected by the metal. As a result, the user may see unwanted light, that is, the reflected light. Therefore, the light absorption layer 1018 can be furthered formed at the junctions P, wherein the light absorption layer 1018 includes a semiconductor metal alloy. In the semiconductor metal alloy, the content of the metal material is 5 wt % to 50 wt %. In the following, different implementing structures of disposing the light absorption layer 1018 in the touch panel 1000 are explained through FIG. 14A and FIG. 14B and FIG. 14C and FIG. 14D.

In the structural designs shown in FIG. 14A and FIG. 14B, the bridge connections B2 can be made of metal, and therefore the light absorption layer 1018 can be disposed in correspondence to the bridge connections B2 of the second electrodes 1014. Through the disposition of the light absorption layer 1018 having good light absorption properties, the aforementioned issue can be avoided. Moreover, in the structural designs of FIG. 14A and FIG. 14B, the light absorption layer 1006 located in the peripheral region 1003 and the light absorption layer 1018 can be fabricated in different process steps.

In the structural designs shown in FIG. 14C and FIG. 14D, the bridge connections B1 can be made of metal, and therefore the light absorption layer 1018 is disposed in correspondence to the bridge connections B1 of the first electrodes 1012. Through the disposition of the light absorption layer 1018 having good light absorption properties, the aforementioned issue can be avoided. Moreover, in the structural designs of FIG. 14C and FIG. 14D, the light absorption layer 1006 located in the peripheral region 1003 and the light absorption layer 1018 can be fabricated in the same process step. Further, although the insulating pattern 1013 in FIG. 14C is illustrated as having an island shape, those having ordinary skill in the art should know that the insulating pattern 1013 can also be layered.

Moreover, based on the disclosed contents of the previous descriptions relating to the substrate structure, those having ordinary skill in the art should know that the touch panel can include any one of the substrate structures mentioned in each of the previous embodiments according to actual needs of the touch panel. For instance, the touch panel 1000 can further include a shielding layer. Specifically, regarding the touch panel 1000, when components such as the decoration layer 1004 and the sensing electrodes 1010 are fabricated on the substrate 1002 after cutting the substrate 1002 to a predetermined size, a gap may be present between the outer edge of the decoration layer 1004 and the border of the substrate 1002, at which instance a shielding layer will need to be formed.

In the following, a touch panel including a shielding layer is explained through FIG. 15.

FIG. 15 is a partial schematic cross-sectional view of a touch panel of the ninth embodiment of the invention. Referring to FIG. 15, the touch panel of the ninth embodiment is essentially similar to the touch panel 1000 of the eighth embodiment, and therefore the same components of the two embodiments are represented by the same reference numerals and are not repeated herein.

The touch panel of the ninth embodiment and the touch panel 1000 of the eighth embodiment are different in that, in the present embodiment, a border 2022 of a substrate 2002 is separated from an outer edge 2020 of the decoration layer 1004 by a distance d2 and the touch panel of the present embodiment includes a shielding layer 2100, wherein the shielding layer 2100 is at least located between the outer edge 2020 of the decoration layer 1004 and the border 2022 of the substrate 2002 and extends to cover at least a portion of a side surface 2024 of the substrate 2002. The material of the shielding layer 2100 is, for instance, ink, photoresist, resin, diamond-like carbon, or any shading material.

Specifically, since the substrate 2002 between the outer edge 2020 of the decoration layer 1004 and the border 2022 of the substrate 2002 usually does not have the function of display, in order to prevent light leaking from the substrate 2002 in the regions or to provide a more desirable appearance to the touch panel, the shielding layer 2100 is disposed to cover the substrate 200 in the regions. Moreover, in FIG. 15, although the shielding layer 2100 is illustrated to cover the entire light absorption layer 1006 and the decoration layer 1004 and extend to cover at least a portion of the side surface 2024 of the substrate 2002, the invention is not limited thereto, as long as the shielding layer 2100 is formed between the outer edge 2020 of the decoration layer 1004 and the border 2022 of the substrate 2002 and on at least a portion of the side surface 2024 of the substrate 2002. Moreover, the shielding layer 2100 can further be partially or completely covered on the side surface 2024 of the substrate 2002 to provide the effect of better light leakage prevention.

Moreover, the configuration of the disposition of the sensing electrodes 1010 in the eighth embodiment is only used as an example and is not used to limit the invention. In other embodiments, the sensing electrodes 1010 can also be sensing electrodes in a single layer.

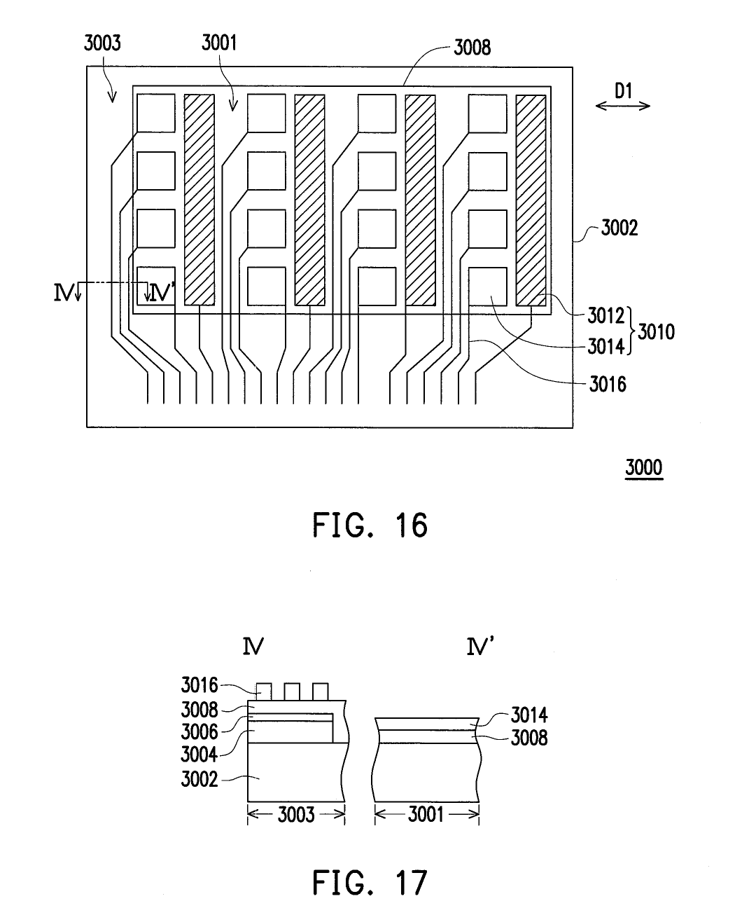

FIG. 16 is a schematic top view of a touch panel of the tenth embodiment of the invention. FIG. 17 is a schematic cross-sectional view of the touch panel of FIG. 16 along line IV-IV′. Referring to FIG. 16 and FIG. 17, the touch panel 3000 includes a substrate 3002, a decoration layer 3004, a light absorption layer 3006, an insulating layer 3008, a plurality of sensing electrodes 3010, and a plurality of transmission lines 3016.

The substrate 3002, the decoration layer 3004, the light absorption layer 3006, the insulating layer 3008, and the transmission lines 3016 can be the same as the equivalents thereof in the eighth embodiment. Therefore, the material, the properties, the functions, and the relative description of each component are not repeated herein.

In the present embodiment, the sensing electrodes 3010 are disposed on the substrate 3002 and located in the operating region 3001 of the substrate 3002. The sensing electrodes 3010 include a plurality of first electrodes 3012 and a plurality of second electrodes 3012, wherein the second electrodes 3014 are disposed adjacent to the first electrodes 3012. Moreover, the first electrodes 3012 and the second electrodes 3014 are alternately arranged along a direction D1, and the second electrodes 3014 are not interlaced with the first electrodes 3012. In other words, the sensing electrodes 3010 of the present embodiment are formed by a single layer. It should be mentioned that, although the touch panel 3000 of the present embodiment is exemplified as having the sensing electrodes 3010 of the structure shown in FIG. 16, the invention is not limited thereto. In other words, the sensing electrodes 3010 can also have other configurations known by those skilled in the art.

The material of the sensing electrodes 3010 is, for instance, a metal mesh, a transparent conductive material, or a combination thereof, wherein the transparent conductive material is, for instance, indium tin oxide, indium zinc oxide, aluminum zinc oxide, or a mixture or layers thereof.

It is known from the disclosed contents of the previous descriptions relating to the touch panel 1000 of the eighth embodiment that, in the tenth embodiment, through the disposition of the decoration layer 3004 and the light absorption layer 3006, not only can the desired visual effects be provided to the touch panel 3000, the transmission lines 3016 in the touch panel 3000 not to be seen by the user can also be effectively shielded to achieve the demand for an enhanced appearance of the touch panel 3000 and reduce the overall thickness of the decoration layer 3004 and the light absorption layer 3006, thereby avoiding the issue of disconnection of the transmission lines 3016 near the peripheral region 3003.

Moreover, in the present embodiment, the decoration layer 3004, the light absorption layer 3006, and the insulating layer 3008 are used as the frame of the touch panel 3000 and are disposed in the peripheral region 3003. However, the invention is not limited thereto. In other embodiments, the decoration layer 3004, the light absorption layer 3006, and the insulating layer 3008 can be disposed only in correspondence to the location of the transmission lines 3016. Alternately, the decoration layer 3004, the light absorption layer 3006, and the insulating layer 3008 can be disposed only for decorative purposes.

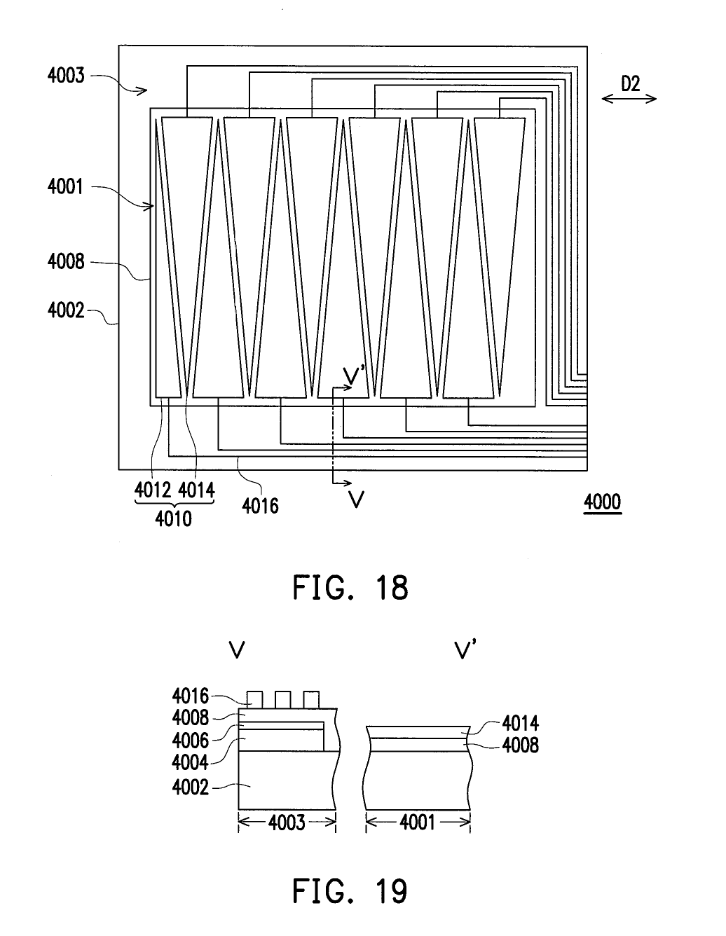

FIG. 18 is a schematic top view of a touch panel of the eleventh embodiment of the invention. FIG. 19 is a schematic cross-sectional view of the touch panel of FIG. 18 along line V-V′. Referring to FIG. 18 and FIG. 19, a touch panel 4000 includes a substrate 4002, a decoration layer 4004, a light absorption layer 4006, an insulating layer 4008, a plurality of sensing electrodes 4010, and a plurality of transmission lines 4016.

The substrate 4002, the decoration layer 4004, the light absorption layer 4006, the insulating layer 4008, and the transmission lines 4016 can be the same as the equivalents thereof in the tenth embodiment. Therefore, the material, the properties, the functions, and the relative description of each component are not repeated herein.

The sensing electrodes 4010 are disposed on the substrate 4002 and located in the operating region 4001 of the substrate 4002. The sensing electrodes 4010 include a plurality of first electrodes 4012 and a plurality of second electrodes 4014, wherein the second electrodes 4014 are disposed adjacent to the first electrodes 3012. Moreover, the first electrodes 4012 and the second electrodes 4014 are alternately arranged along a direction D2. In comparison to the tenth embodiment, the first electrodes 3012 and the second electrodes 3014 of the sensing electrodes 3010 are rectangular configurations and the first electrodes 4012 and the second electrodes 4014 of the sensing electrodes 4010 in the present embodiment are triangular configurations. Therefore, similarly to the sensing electrodes 3010, the sensing electrodes 4010 are also sensing electrodes in a single layer. It should be mentioned that, although the touch panel 4000 of the present embodiment is exemplified as having the sensing electrodes 4010 of the structure shown in FIG. 18, the invention is not limited thereto. In other words, the sensing electrodes 4010 can also have other configurations known by those skilled in the art.

The material of the sensing electrodes 4010 is, for instance, a metal mesh, a transparent conductive material, or a combination thereof, wherein the transparent conductive material is, for instance, indium tin oxide, indium zinc oxide, aluminum zinc oxide, or a mixture or layers thereof.

It is known from the disclosed contents of the previous descriptions relating to the touch panel 1000 of the eighth embodiment that, in the tenth embodiment, through the disposition of the decoration layer 4004 and the light absorption layer 4006, not only can the desired visual effects be provided to the touch panel 4000, the transmission lines 4016 in the touch panel 4000 not to be seen by the user can also be effectively shielded to achieve the demand for an enhanced appearance of the touch panel 4000 and reduce the overall thickness of the decoration layer 4004 and the light absorption layer 4006, thereby avoiding the issue of disconnection of the transmission lines 4016 near the peripheral region 4003.

Moreover, in the present embodiment, the decoration layer 4004, the light absorption layer 4006, and the insulating layer 4008 are used as the frame of the touch panel 4000 and are disposed in the peripheral region 4003. However, the invention is not limited thereto. In other embodiments, the decoration layer 4004, the light absorption layer 4006, and the insulating layer 4008 can be disposed only in correspondence to the location of the transmission lines 4016. Alternately, the decoration layer 4004, the light absorption layer 4006, and the insulating layer 4008 can be disposed only for decorative purposes. It should be noted that although the embodiments of the touch panel mentioned above are illustrated with the structure that the sensing electrodes and the transmission lines are disposed on a substrate together with the decoration layer and the light absorption, it is understood that as long as the transmission lines can be shielded by the decoration layer and the light absorption in the projection direction, the sensing electrodes and the transmission lines can be disposed on other substrate(s) without the decoration layer and the light absorption, for example, the decoration layer and the light absorption can be disposed on a cover plate, and the sensing electrodes and the transmission lines can be disposed on a substrate which is indirectly or directly bonded to the cover plate with an optical adhesive.

Based on the above, in the substrate structures and the touch panels provided in the embodiments, through the disposition of a light absorption layer having good light absorption properties on the decoration layer, the shading effects can further be improved, thereby providing the desired visual effects to the user. Moreover, in the touch panels of the embodiments, through the disposition of a light absorption layer on the decoration layer, the demand for an enhanced appearance can be achieved. At the same time, the overall thickness of the decoration layer and the light absorption layer can be reduced to avoid the issue of disconnection near the peripheral region.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A substrate structure, comprising:
a substrate;
a first decoration layer disposed on the substrate; and
a light absorption layer disposed on the first decoration layer, wherein the first decoration layer is located between the substrate and the light absorption layer, and a material of the light absorption layer comprises a semiconductor metal alloy.

2. The substrate structure of claim 1, wherein a semiconductor material of the semiconductor metal alloy comprises silicon, germanium, tin, indium, or an alloy thereof and a metal material of the semiconductor metal alloy comprises aluminum, silver, copper, chromium, platinum, or an alloy thereof.

3. The substrate structure of claim 1, wherein a thickness of the light absorption layer is between 20 nm and 500 nm.

4. The substrate structure of claim 1, wherein a material of the first decoration layer comprises ink, photoresist, resin, or a combination thereof.

5. The substrate structure of claim 1, wherein a material of the first decoration layer is white ink or colored ink.

6. The substrate structure of claim 1, further comprising a second decoration layer disposed on the light absorption layer, wherein a material of the second decoration layer comprises ink, photoresist, resin, or diamond-like carbon.

7. The substrate structure of claim 1, wherein a content of a metal material in the semiconductor metal alloy is 5 wt % to 50 wt %.

8. The substrate structure of claim 1, further comprising an insulating layer disposed on the light absorption layer.

9. The substrate structure of claim 8, wherein a material of the insulating layer comprises silicon oxide, titanium oxide, or aluminum oxide.

10. The substrate structure of claim 1, wherein the first decoration layer has an outer edge separated from a border of the substrate by a distance and the substrate structure further comprises a shielding layer at least located between the outer edge and the border of the substrate and extending to cover at least a portion of a side surface of the substrate.

11. The substrate structure of claim 1, wherein the first decoration layer is a single-layer structure.

12. The substrate structure of claim 1, wherein the first decoration layer is a multilayer structure.

13. The substrate structure of claim 12, wherein at least two layers of structures of the multilayer structure have different sizes.

14. A touch panel, comprising:
a substrate, having an operating region and a peripheral region surrounding the operating region;
a first decoration region disposed on the substrate and located in the peripheral region;
a light absorption layer disposed on the first decoration layer, wherein the first decoration layer is located between the substrate and the light absorption layer, and the light absorption layer comprises a semiconductor metal alloy; and
a plurality of sensing electrodes disposed on the substrate and located in the operating region.

15. The touch panel of claim 14, wherein a semiconductor material of the semiconductor metal alloy comprises silicon, germanium, tin, indium, or an alloy thereof and a metal material of the semiconductor metal alloy comprises aluminum, silver, copper, chromium, platinum, or an alloy thereof.

16. The touch panel of claim 14, wherein a thickness of the light absorption layer is 20 nm to 500 nm.

17. The touch panel of claim 14, wherein a material of the first decoration layer comprises ink, photoresist, resin, or a combination thereof.

18. The touch panel of claim 14, wherein a material of the first decoration layer is white ink or colored ink.

19. The touch panel of claim 14, further comprising a plurality of transmission lines electrically connecting the sensing electrodes and extending from the operating region into the peripheral region.

20. The touch panel of claim 19, wherein the light absorption layer and the first decoration layer are located between the transmission lines in the peripheral region and the substrate.

21. The touch panel of claim 14, further comprising a second decoration layer disposed on the light absorption layer, wherein a material of the second decoration layer comprises ink, photoresist, resin, or diamond-like carbon.

22. The substrate structure of claim 14, wherein a content of a metal material in the semiconductor metal alloy is 5 wt % to 50 wt %.

23. The touch panel of claim 14, further comprising an insulating layer disposed on the light absorption layer.

24. The touch panel of claim 23, wherein a material of the insulating layer comprises silicon oxide, titanium oxide, or aluminum oxide.

25. The touch panel of claim 14, wherein the first decoration layer has an outer edge separated from a border of the substrate by a distance and the touch panel further comprises a shielding layer at least located between the outer edge and the border of the substrate and extending to cover at least a portion of a side surface of the substrate.

26. The touch panel of claim 14, wherein the first decoration layer is a single-layer structure.

27. The touch panel of claim 14, wherein the first decoration layer is a multilayer structure.

28. The touch panel of claim 27, wherein at least two layers of structures of the multilayer structure have different sizes.

29. The touch panel of claim 14, wherein the sensing electrodes comprise a plurality of first electrodes and a plurality of second electrodes, the first electrodes and the second electrodes are electrically independent from each another, the first electrodes are interlaced with the second electrodes to form a plurality of junctions, and the light absorption layer is further located at the junctions.
